(19) United States
(12) Patent Application Publication
(10) Pub. No.: US 2007/0207406 A1
(43) Pub. Date: Sep. 6, 2007

(54) ANTI-REFLECTIVE COATINGS USING VINYL ETHER CROSSLINKERS

(76) Inventors: Douglas J. Guerrero, Rolla, MO (US); Ramil-Marcelo L. Mercado, Rolla, MO (US)

Correspondence Address: HOVEY WILLIAMS LLP, 2405 GRAND BLVD., SUITE 400, KANSAS CITY, MO, 64108, US

(21) Appl. No.: 11/683,309

(22) Filed: Mar. 7, 2007

Related U.S. Application Data
(63) Continuation-in-part of application No. 11/105,862, filed on Apr. 14, 2005, now abandoned.
(60) Provisional application No. 60/566,329, filed on Apr. 29, 2004.

(51) Int. Cl. G03C 1/00

(52) U.S. Cl. 430/270.1

(57) ABSTRACT

Novel, developer soluble anti-reflective coating compositions and methods of using those compositions are provided. The compositions comprise a polymer and/or oligomer having acid functional groups and dissolved in a solvent system along with a cross linker, a photoacid generator, and optionally a chromophore. The preferred acid functional group is a carboxylic acid, while the preferred crosslinker is a vinyl ether crosslinker. In use, the compositions are applied to a substrate and thermally crosslinked. Upon exposure to light (and optionally a post exposure bake), the cured compositions will decrosslink, rendering them soluble in typical photoresist developing solutions (e.g., alkaline developers). In one embodiment, the compositions can be used to form ion implant areas in microelectronic substrates.

### RELATED APPLICATIONS

This application claims the priority benefit of a provisional application entitled ANTI-REFLECTIVE COATING USING VINYL ETHER CROSSLINKERS, Ser. No. 60/566,329, filed Apr. 29, 2004, incorporated by reference herein. This application is a continuation-in-part of U.S. patent application Ser. No. 11/105,862, filed on April 14, 2005, and incorporated by reference herein.

### FEDERALLY SPONSORED RESEARCH/DEVELOPMENT PROGRAM

This invention was made with government support under contract number DASG60-01-C-0047 awarded by the U.S. Army Space and Missile Defense Command. The United States government has certain rights in the invention.

### BACKGROUND OF THE INVENTION

1. Field of the Invention

The present invention is concerned with novel developer soluble anti-reflective coating compositions and methods of using the same to form ion implanted areas in microelectronic substrates.

2. Description of the Prior Art

As feature sizes shrink to less than 80 nm, new and more advanced materials will be needed to achieve the goals set by the semiconductor industry. Improvements in both photoresists and bottom anti-reflective coatings are needed to achieve high-resolution lithography targets. For example, resist thickness loss that occurs during the bottom anti-reflective coating and substrate etch steps becomes a critical issue because new resists are much thinner than older generation materials. While resist thickness is being reduced, bottom anti-reflective coating thickness is not expected to decrease at the same rate, which further complicates the problem of resist loss. A solution to this problem is to eliminate the bottom anti-reflective coating etch step by using a wet-developable bottom anti-reflective coating.

Wet developable bottom anti-reflective coatings have typically utilized a polyamic acid soluble in alkaline media as a polymer binder, thus allowing the bottom anti-reflective coating to be removed when the resist is developed. These traditional wet-developable bottom anti-reflective coatings are rendered insoluble in resist solvents taking advantage of a thermally driven amic acid-to-imide conversion. This process works well, however, it has two limitations: (1) the bake temperature window can be narrow (less than 10° C.) where the bottom anti-reflective coating remains insoluble in organic solvents but soluble in alkaline developer; and (2) the wet-develop process is isotropic, meaning the bottom anti-reflective coating is removed vertically at the same rate as horizontally, which leads to undercutting of the resist lines. While this is not a problem with larger geometries (greater than 0.2 micron), it can easily lead to line lifting and line collapse at smaller line sizes.

### SUMMARY OF THE INVENTION

The present invention overcomes the problems of prior art anti-reflective coatings by providing new developer soluble, photosensitive compositions that are useful in the manufacture of microelectronic devices.

In more detail, the inventive compositions comprise a compound selected from the group consisting of polymers, oligomers, and mixtures thereof dissolved or dispersed in a solvent system. The compound is preferably present in the composition at a level of from about 0.5-10% by weight, preferably from about 0.5-5% by weight, and even more preferably from about 1-4% by weight, based upon the total weight of all ingredients in the composition taken as 100% by weight.

If the compound is a polymer, it is preferred that the average molecular weight be from about 1,000-100,000 Daltons, and more preferably from about 1,000-25,000 Daltons. Preferred polymers include those selected from the group consisting of aliphatic polymers, acrylates, methacrylates, polyesters, polycarbonates, novolaks, polyamic acids, and mixtures thereof

If the compound is an oligomer, it is preferred that the molecular weight be from about 500-3,000 Daltons, and more preferably from about 500-1,500 Daltons. Preferred oligomers include substituted and unsubstituted acrylates, methacrylates, novolaks, isocyanurates, glycidyl ethers, and mixtures thereof

Regardless of whether the compound is an oligomer or polymer, and regardless of the structure of the polymer backbone or oligomer core, it is preferred that the compound comprise an acid functional group. The acid group is preferably present in the compound at a level of at least about 5% by weight, preferably from about 5-90% by weight, and even more preferably from about 5-50% by weight, based upon the total weight of the compound taken as 100% by weight. Preferred acid groups are groups other than phenolics, such as carboxylic acids (—COOH).

Unlike prior art compositions, the acid group is preferably not protected by a protective group. That is, at least about 95%, preferably at least about 98%, and preferably about 100% of the acid groups are free of protective groups. A protective group is a group that prevents the acid from being reactive.

Because protective groups are not necessary with the present invention, it is also preferred that the compound is not acid-sensitive. An acid-sensitive polymer or oligomer is one that contains protective groups that are removed, decomposed, or otherwise converted in the presence of an acid.

In another embodiment, a combination of protected acid groups and unprotected acid groups could be utilized. In these embodiments, the molar ratio of protected acid groups to unprotected acid groups is from about 1:3 to about 3:1, and more preferably from about 1:2 to about 1:1.

It is also preferred that the inventive compositions comprise a chromophore (light attenuating compound or moiety). The chromophore can be bonded with the compound (either to a functional group on the compound or directly to the polymer backbone or oligomer core), or the chromophore can simply be physically mixed in the composition. The chromophore should be present in the composition at a level of from about 5-50% by weight, and preferably from about 20-40% by weight, based upon the total weight of the compound taken as 100% by weight. The chromophore is selected based upon the wavelength at which the compositions will be processed. For example, at wavelengths of 248 nm, preferred chromophores include naphthalenes (e.g., naphthoic acid methacrylate, 3,7-dihydroxynaphthoic acid), heterocyclic chromophores, carbazoles, anthracenes (e.g., 9-anthracene methyl methacrylate, 9-anthracenecarboxylic acid), and functional moieties of the foregoing. At wavelengths of 193 nm, preferred chromophores include substituted and unsubstituted phenyls, heterocyclic chromophores (e.g., furan rings, thiophene rings), and functional moieties of the foregoing. The preferred inventive compositions will also include a crosslinker. Preferred crosslinkers are vinyl ether crosslinkers. It is preferred that the vinyl ether crosslinkers be multi-functional, and more preferably tri- and tetra-functional.

Preferred vinyl ether crosslinkers have the formula
R—(X—O—CH═CH₂)ₙ,
where R is selected from the group consisting of aryls (preferably C₆-C₁₂) and alkyls (preferably C₁-C₁₈, and more preferably C₁-C₁₀, each X is individually selected from the group consisting of; alkyls (preferably C₁-C₁₈, and more preferably C₁-C₁₀); alkoxys (preferably C₁-C₁₈, and more preferably C₁-C₁₀); carboxys; and combinations of two or more of the foregoing, and n is 2-6. The most preferred vinyl ether crosslinkers include those selected from the group consisting of ethylene glycol vinyl ether, trimethylolpropane trivinyl ether, 1,4-cyclohexane dimethanol divinyl ether, and mixtures thereof. Another preferred vinyl ether crosslinker has a formula selected from the group consisting of

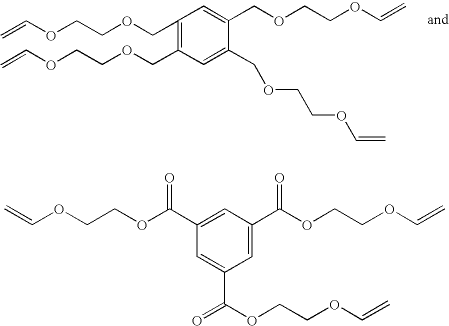

The preferred compositions also contain a catalyst. The preferred catalyst is an acid generator, and particularly a photoacid generator (“PAG,” both ionic and/or non-ionic). Any PAG that produces an acid in the presence of light is suitable. Preferred PAGs include onium salts (e.g., triphenyl sulfonium perfluorosulfonates such as triphenyl sulfonium nonaflate and triphenyl sulfonium triflate), oxime-sulfonates (e.g., those sold under the name CGI® by CIBA), and triazines (e.g., TAZ108® available from Midori Kagaku Company).

The compositions preferably comprise from about 0.1-10% by weight of catalyst, and more preferably from about 1-5% by weight of catalyst, based upon the total weight of the polymer and oligomer solids in the composition taken as 100% by weight.

Although a thermal acid generator (“TAG”) can be included in the inventive compositions, in a preferred embodiment the composition is essentially free of TAGs. That is, any TAGs are present at very low levels of less than about 0.05% by weight, and preferably about 0% by weight, based upon the total weight of the composition taken as 100% by weight.

It will be appreciated that a number of other optional ingredients can be included in the compositions as well. Typical optional ingredients include surfactants, amine bases, and adhesion promoters.

Regardless of the embodiment, the anti-reflective compositions are formed by simply dispersing or dissolving the polymers, oligomers, or mixtures thereof in a suitable solvent system, preferably at ambient conditions and for a sufficient amount of time to form a substantially homogeneous dispersion. The other ingredients (e.g., crosslinker, PAG) are preferably dispersed or dissolved in the solvent system along with the compound.

Preferred solvent systems include a solvent selected from the group consisting of propylene glycol methyl ether acetate (PGMEA), propylene glycol methyl ether (PGME), propylene glycol n-propyl ether (PnP), ethyl lactate (EL), and mixtures thereof. Preferably, the solvent system has a boiling point of from about 50-250° C., and more preferably from about 100-175° C. The solvent system should be utilized at a level of from about 80-99% by weight, and preferably from about 95-99% by weight, based upon the total weight of the composition taken as 100% by weight.

The method of applying the compositions to a substrate (such as a microelectronic substrate) simply comprises applying a quantity of a composition hereof to the substrate surface by any known application method (including spin-coating). The substrate can be any conventional circuit substrate, and suitable substrates can be planar or can include topography (e.g., contact or via holes, trenches). Exemplary substrates include silicon, aluminum, tungsten, tungsten silicide, gallium arsenide, germanium, tantalum, tantalum nitrite, SiGe, low k dielectric layers, dielectric layers (e.g., silicon oxide), and ion implant layers. The use of the inventive compositions to form ion implant layers is described in more detail below.

After the desired coverage is achieved, the resulting layer should be heated to a temperature of from about 100-250° C., and preferably from about 120-200° C., to induce crosslinking of the compound in the layer. In embodiments where the polymer or oligomer includes a carboxylic acid group, and the crosslinker is a vinyl ether crosslinker, the crosslinked polymers or oligomers will comprise acetal linkages having the formula 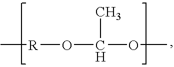
where R is selected from the group consisting of aryls (preferably from about C₆ to about C₁₂), —CO—, —SO—, —S—, and —CONH—.

It is preferred that the inventive compositions be applied in quantities such that the thickness of the layer after curing or crosslinking will be within about 20% of the first maximum thickness of the composition. The first maximum thickness of a composition is defined as:

$$First Maximum Thickness = \frac{λ}{2 n} ,$$

where λ is the wavelength of use, and n is the real component of the refractive index of the composition. Even more preferably, the thickness of the crosslinked layer is within about 15%, even more preferably within about 10%, and even more preferably within about 5% of the first maximum thickness of the composition. It has been discovered that use of a photosensitive anti-reflective coating at these thicknesses results in improved properties, including the ability to print structures with critical dimension control and to provide adequate coverage for reflection control over topography.

The crosslinked layer will be sufficiently crosslinked that it will be substantially insoluble in typical photoresist solvents. Thus, when subjected to a stripping test, the inventive coating layers will have a percent stripping of less than about 5%, preferably less than about 1%, and even more preferably about 0%. The stripping test involves first determining the thickness (by taking the average of measurements at five different locations) of a cured layer. This is the average initial film thickness. Next, a solvent (e.g., ethyl lactate) is puddled onto the cured film for about 10 seconds, followed by spin drying at about 2,000-3,500 rpm for about 20-30 seconds to remove the solvent. The thickness is measured again at five different points on the wafer using ellipsometry, and the average of these measurements is determined. This is the average final film thickness.

The amount of stripping is the difference between the initial and final average film thicknesses. The percent stripping is:

$$\% stripping = ( \frac{amount of stripping}{initial average film thickness} ) \times 100.$$

The crosslinked layers will also have superior light absorbance. The n value of this cured anti-reflective layer or coating will be at least about 1.3, and preferably from about 1.4-2.0, while the k value will be least about 0.1, and preferably from about 0.2-0.8, at the wavelength of use (e.g., 157 nm, 193 nm, 248 nm, 365 nm). The OD of the cured layers will be at least about 5/μm, preferably from about 5-15/μm, and even more preferably from about 10-15 μm, at the wavelength of use (e.g., 157 nm, 193 nm, 248 nm, 365 nm).

After the layers are cured, further steps can be carried out as necessary for the particular manufacturing process. For example, a photoresist can be applied to the cured layer and subsequently patterned by exposure to light of the appropriate wavelength followed by development of the exposed photoresist. Preferably, the layer is also subjected to a post exposure bake.

Advantageously, as the photoresist is exposed to light, so is the inventive coating. Upon exposure to light, an acid is generated from the PAG, and this acid “decrosslinks” the compound in the layer. That is, the acid catalyzes breaking of the bond that was formed between the compound and the crosslinker upon thermal crosslinking. When a carboxylic acid is the acid group on the polymer or oligomer, decrosslinking results in the formation of the same polymer or oligomer originally present in the composition as well as an alcohol and an acetylaldehyde. This reaction is demonstrated in the scheme below (where R represents the polymer backbone or oligomer core, and R′ represents the remainder of the vinyl ether crosslinker).

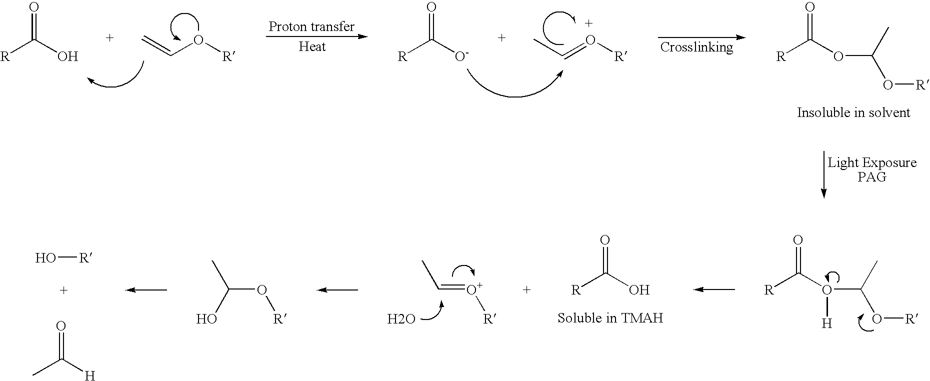

It will be appreciated that after this decrosslinking has occurred, the inventive coatings are rendered developer soluble. That is, the cured compositions that have been exposed to light can be substantially (and preferable completely) removed with conventional aqueous developers such as tetramethyl ammonium hydroxide and (KOH developers. Some of these developers are commercialized under the names PD523AD (available from JSR Micro), MF-319 (available from Rohm & Haas, Massachusetts), and NMD3 (available from TOK, Japan) developers. At least about 95%, preferably at least about 99%, and even more preferably 100% of the inventive coatings will be removed by a base developer such as tetramethyl ammonium hydroxide and/or KOH developers. This high percent solubility in commercially-available developers after light exposure is a significant advantage over the prior art as this shortens the manufacturing process and makes it less costly.

### BRIEF DESCRIPTION OF THE DRAWINGS

FIG. 1 is a drawing illustrating an ion implantation process utilizing the inventive compositions;

FIG. 2 is a graph depicting the reflectivity curve of the composition of Example 5 at 193 nm;

FIG. 3 is a graph depicting the reflectivity curves of the composition of Example 6 at 193 and 248 nm;

FIG. 4 is a graph depicting the reflectivity curve of the composition of Example 7 at 365 nm; and

FIG. 5 is a graph depicting the reflectivity curve of the composition of Example 8 at 248 nm.

### DETAILED DESCRIPTION OF THE PREFERRED EMBODIMENTS

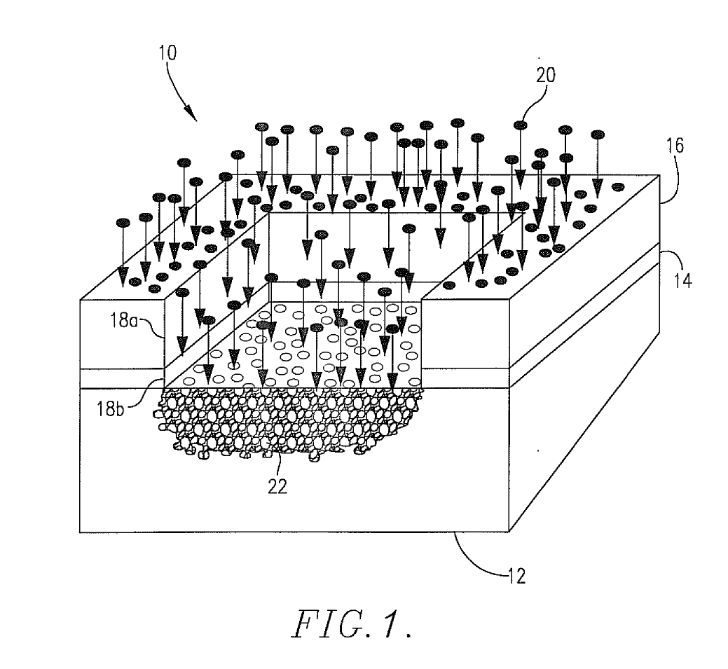

FIG. 1 illustrates the ion implantation process. A structure 10 comprises a substrate 12 with a cured anti-reflective layer 14 adjacent substrate 12. Substrate 12 can be any conventional substrate used for semiconductor manufacturing, including those selected from the group consisting of silicon, gallium arsenide, germanium, SiGe, silicon oxide, silicon nitride, and silicon oxynitride substrates.

Anti-reflective layer 14 is formed from the inventive anti-reflective composition described herein. A photoresist 16 is adjacent anti-reflective layer 14. Photoresist 16 is patterned according to prior art methods (i.e, exposed to light and developed with a developer solution) to form an opening 18a (such as a contact hole, via hole, trench, etc.) in photoresist 16. However, unlike prior art ion implantation methods and because the portions of the inventive composition exposed to light become developer soluble after exposure as described above, an opening 18b is also formed in anti-reflective layer 14 during development of the photoresist 16. It can be seen from FIG. 1 that openings 18a and 18b are in communication with one another (i.e., aligned to at least some extent so that substrate 12 is exposed).

Ions 20 are generated from a dopant by an ion source (not shown) using known processes. Some preferred ions 20 for use with the present invention are those selected from the group consisting of ions of the elements of Groups III-V of the Periodic Table, with ions of boron, nitrogen, phosphorus, arsenic, boron difluoride, indium, antimony, germanium, silicon, carbon, and gallium being particularly preferred. Other preferred ions are selected from the group consisting of hydrogen, argon, beryllium, fluorine, oxygen, and helium.

The generated ions 20 are accelerated at energy levels sufficiently high that the ions will penetrate the substrate 12. Preferred energy levels are from about 80 eV to about 4 MeV, preferably from about 100 eV to about 1.5 MeV, and more preferably from about 200 eV to about 1 MeV. Typical ion doses would be from about log atoms/cm² to about 10¹⁸ atoms/cm², and preferably from about 10¹¹atoms/cm² to about 10¹⁷ atoms/cm². The accelerated ions 20 are focused by known processes. One such process involves using a series of electrostatic and magnetic lenses until the beam reaches the desired diameter.

The beam is directed at substrate 12. As will be understood by those skilled in this art, the angle of the beam can be adjusted to control ion depth in the substrate. As shown in FIG. 1, anti-reflective layer 14 and resist 16 serve to protect areas of substrate 12 where ions 20 are not desired, while openings 18a and 18b provide access to substrate 12 by the ions 20. As a result, implant area 22 is formed in substrate 12.

It will be appreciated that FIG. 1 depicts only a small section of the overall structure 10. Thus, anti-reflective layer 14 and photoresist 16 may have a number of openings formed therein. These openings can be adjusted to the size and shape necessary to implant ions in the substrate in the locations appropriate for the end use. Furthermore, there could be an additional layer(s) (e.g., an oxide layer) under the anti-reflective layer 14, if desired.

### EXAMPLES

The following examples set forth preferred methods in accordance with the invention. It is to be understood, however, that these examples are provided by way of illustration and nothing therein should be taken as a limitation upon the overall scope of the invention.

### Materials and Methods

1. In-house Preparation of Tetrafunctional Vinyl Ether Crosslinker

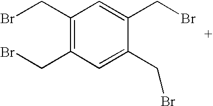

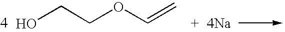

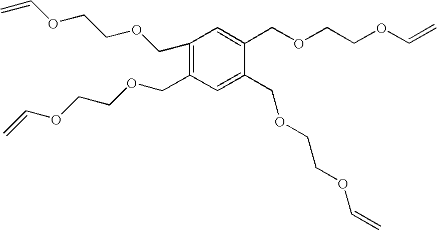

| | | | | |
|---|---|---|---|---|
| FW: | 449.79 | 88.11 | 23 | 478.55 |
| gr: | 3.6976 | 2.9 | 0.8 | |
| mmol: | 8.22 | 32.9 | 34.8 | |

The reaction was carried out under N₂ in a 250-ml, 3-neck, round bottom flask. The Na cube was rinsed with hexane prior to use to remove mineral oil, placed quickly in a vial for weighing, and then transferred to the flask, which contained 50 ml tetrahydrofuran (THF). An alcohol solution in THF (20 ml) was added dropwise through an addition funnel (about 15 minutes), and then heated to reflux until all of the Na was dissolved (about 30 minutes). The solution was light yellow and homogeneous. Tetrabromo durene dissolved in THF (15 ml) was added to the reaction flask dropwise (about 30 minutes), and allowed to reflux overnight. Upon addition, the mixture became heterogenous (NaBr precipitates).

After cooling, the salts were filtered and rinsed with THF. The THF was removed in a rotary evaporator, and the remaining oil was redissolved in CHCl₃ (25 ml). The chloroform solution was washed with water (2×25 ml), and then with brine (saturated NaCl, 25 ml). The organic layer was dried by passing it over a bed of silica gel. The solvent was removed. The product was left under vacuum for further drying.
2. In-house Preparation of Trifunctional Vinyl Ether Crosslinker

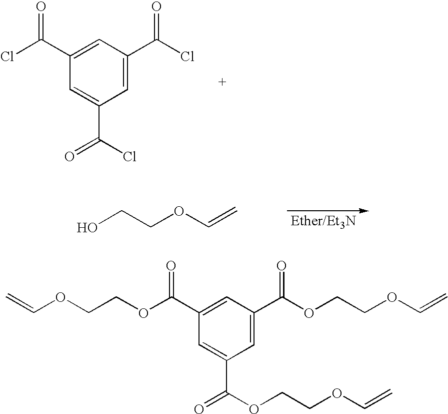

Ethylene glycol vinyl ether (6 grams) and triethyl amine (7.5 ml) were mixed in ether (40 ml) and treated dropwise with a solution of trimesic acid chloride (6 grams) in ether (40%). After addition, the mixture was heated to reflux for 1.5 hours. Residual salts were removed by filtration, and the ether solution was washed with 10% NaOH (2×25 ml), washed with water (25 ml), and then dried over anhydrous magnesium sulfate. After removal of the solvent under pressure, light yellow oil was collected (69% yield).
3. Vinyl Ether Crosslinker Synthesis

In this procedure, 25.15 g of tetramethylene glycol monovinyl ether, 22.91 g triethylamine, and 250 ml THF were added to a 500-ml, 2-necked flask equipped with a stir bar, addition funnel, condenser, and nitrogen inlet and outlet. The solution was stirred under a low flow of nitrogen and immersed in an ice water bath.

Next, 20.00 g of 1,3,5-benzenetricarbonyl trichloride were dissolved in 50 ml THF in a closed Erlenmeyer flask. This solution was transferred to the addition funnel. The contents of the addition funnel were added dropwise (over approximately 15 minutes) to the stirring solution of tetramethylene glycol monovinyl ether, triethylamine, and THF. A white precipitate formed up on contact. After addition was completed, the flask was removed from the ice water bath and stirred for approximately 2 hours at room temperature (about 20° C.). The flask was then immersed in an oil bath, and the slurry was heated and kept at reflux for 3 hours. The flask was removed from the heat and allowed to cool to room temperature.

The slurry was then suction filtered to give a yellow solution. The yellow solution was concentrated using a rotavap to remove the THF. The yellow oil was dissolved using 100 ml of diethylether. This solution was washed and extracted twice with 25-ml portions of aqueous, 12.5% tetramethylammonium hydroxide. This was followed with two washing and extraction steps with 50 ml of deionized water. The ether layer was allowed to settle out and collected. The ether layer was dried by mixing with 5.0 g of activated basic alumina. The mixture was stirred for 1 hour and gravity filtered. The clear yellow liquid was concentrated in a rotavap to give a yellow viscous oil.

### Example 1

### Polymer Composition Without Acid Sensitive Groups

A homopolymer of methacryloyloxy ethyl phthalate (28.9 mmol, obtained from Aldrich) and 2,2′-azobisisobutyronitrile (“AIBN,” 0.58 mmol radical initiator, obtained from Aldrich) were mixed in 50 ml THF (obtained from Aldrich) under a nitrogen atmosphere and heated to reflux for 15 hours. The reaction was allowed to cool, concentrated to about 25 ml, and then precipitated into 200 ml hexane. After filtration and drying, about 8 grams of the remaining white powder were collected. The polymer molecular weight (“Mw”) was measured by using polystyrene standards and gel permeation chromatography (“GPC”) and was determined to be 68,400.

A 193-nm bottom anti-reflective coating was prepared as follows: A 3% solids formulation containing ethyl lactate (“EL,” obtained from General Chemical), the polymer prepared above, 28% by weight Vectomer 5015 (a vinyl ether crosslinker obtained from Aldrich), and 4% by weight triphenyl sulfonium nonaflate (a PAG, obtained from Aldrich) was prepared and filtered through 0.1-micron endpoint filter. The crosslinker and PAG amounts were based on the weight of the polymer,

The above formulation was spin coated at 1,500 rpm on a silicon substrate and then baked at 160° C. The films were rinsed with EL to determine resistance to the resist solvent, exposed to light for 2 seconds, heated in a post-exposure bake (“PEB”) at 130° C., and immersed in developer (tetramethylammonium hydroxide or “TMAH,” sold under the name PD523AD, obtained from JSR Micro) for 60 seconds to decrosslink and remove the bottom anti-reflective coating. Table 1 below shows that the bottom anti-reflective coating had good solvent resistance, and that it could only be removed by an alkaline developer after exposure. This example shows that a polymer having an acid-sensitive group is not required for the crosslinking/decrosslinking process.

TABLE 1

| | | | | | Thickness | |
|---|---|---|---|---|---|---|
| | | | Thickness | | After | |
| | Thickness | | After | | Exposure, | |
| | After | | Development | | PEB^{a}, | |
| Initial | 20 sec. | | (No | | and | |
| Thickness | EL Rinse | % | Exposure) | % | Development | % |
| (Å) | (Å) | Loss | (Å) | Loss | (Å) | Loss |
| 619 | 590 | 4.7 | 712 | 0 | 65 | 90 |

^{a}Post-exposure bake

### Example 2

### Bottom Anti-Reflective Coating Containing Chromophore, Acid, and Dissolution Enhancer

Methacrylic acid (“MAA,” 31.2 mmol, obtained from Aldrich), tert-butyl methacrylate (“tBMA,” 26.0 mmol, obtained from Aldrich), 9-anthracene methyl methacrylate (“9-AMMA,” 14.5 mmol, obtained from St-Jean Photochemicals Inc.), and AIBN (1.4 mmol) were mixed in 60 ml THF under nitrogen atmosphere and heated to reflux for 19 hours. The reaction was allowed to cool, was concentrated to about 35 ml, and was then precipitated into 150 ml hexane. After filtration and drying, about 10 grams of a light yellow powder were collected. The polymer Mw, measured by using polystyrene standards and GPC, was determined to be 23,800.

A 3% solids formulation containing the polymer, PGME (obtained from General Chemical), PGMEA (obtained from General Chemical), 10% tetrafunctional vinyl ether cross linker prepared in-house as described above, and 4% triphenyl sulfonium triflate (a PAG obtained from Aldrich) was prepared and filtered through a 0.1-micron endpoint filter. The crosslinker and PAG amounts were based on polymer weight. The above formulation was spin coated at 1,500 rpm onto a silicon substrate and then baked at 160° C. The optical constants at 248 nm were measured using a variable angle spectroscopic ellipsometer (“VASE”) and were determined to be k=0.42 and n=1.4589. The film was rinsed with EL to test resistance to a resist solvent. After a rinse and spin dry cycle, no change in film thickness occurred. The cured film was immersed in 0.26 N TMAH solution, and no thickness loss occurred. However, after the film was exposed to light from a mercury-xenon lamp for 2 seconds and underwent a subsequent post-exposure bake at 130° C. for 90 seconds, the film became soluble in developer.

### Example 3

### Control of Optical Properties by Polymer Composition

Several polymers were prepared using the procedure in Example 2 and using varying amounts of chromophore (9-AMMA) in order to demonstrate control of the optical properties of the bottom anti-reflective coating while maintaining dissolution properties. A 3% solids formulation containing PGME, PGMEA, 10% tetrafunctional vinyl ether crosslinker prepared in-house as described above, and 4% triphenyl sulfonium triflate PAG was prepared and filtered through a 0.1-micron endpoint filter.

Table 2 shows that by increasing chromophore loading in the polymer, optical density, and substrate reflectivity can be controlled.

TABLE 2

| | | | | | Reflectivity at 1st |
|---|---|---|---|---|---|
| 9-AMMA | | n | | 1st Minimum | Minimum |
| (Mole %)^{a} | k value | value | OD/μm | Thickness (Å) | Thickness (%) |
| 10 | 0.27 | 1.52 | 6.1 | 660 | 2.6 |
| 20 | 0.42 | 1.459 | 10.8 | 660 | 0.08 |
| 30 | 0.54 | 1.462 | 13.3 | 620 | 0.87 |

^{a}based upon total moles of solids in composition

### Example 4

### Comparative Example with Phenolic Polymer

A comparative example was prepared to demonstrate that vinyl ether crosslinking with a phenolic resin does not provide sufficient crosslinking density to prevent stripping by photoresist solvent.

In this procedure, 0.5 grams of polyhydroxystyrene (“PHS,” obtained from DuPont), 0.02 grams of a triazine PAG (TAZ107, obtained from Midori Kagaku Company), 8.5 grams of EL, and various amounts of triscarboxyphenyl trivinyl ether prepared in-house were mixed and filtered through a 0.1-micron endpoint filter. Two additional formulations were also prepared in which 9-anthracene carboxylic acid (“9-ACA,” a chromophore obtained from Aldrich) were added to the composition to form a bottom anti-reflective coating for 248-nm lithography. Films were spin coated onto silicon substrates and then baked at varying temperatures up to 205 ° C. Table 3 shows the results obtained. In all cases, the bottom anti reflective coating stripped completely when rinsed with EL.

TABLE 3

| | | | | | EL |
|---|---|---|---|---|---|
| | | | | | Stripping |
| | | Bake | | | (% |
| | | Tempera- | | | change |
| Poly- | Crosslinker:PHS | ture | | Chromo- | in film |
| mer | Ratio | (° C.) | PAG | phore | thickness) |
| PHS | 2:1 | 150, 205 | TAZ107 | — | 100 |
| PHS | 4:1 | 150, 205 | TAZ107 | — | 100 |
| PHS | 2:1 | 100-205^{a} | TAZ107 | 9-ACA | 100 |
| PHS | 4:1 | 100-205 | TAZ107 | 9-ACA | 100 |

^{a}tests were carried out at 10-degree intervals through this temperature range.

### Example 5

1. Polymer Preparation

In this procedure, 21.29 g styrene, 26.17 g t-butyl methacrylate, 25.22 g methacrylic acid, and 491.84 g PGME were added to a 1000-ml, 3-necked flask equipped with a magnetic stir bar, thermometer, addition funnel with nitrogen inlet, and condenser. A solution of 1.81 g AIBN and 164.32 g PGME was added to the addition funnel. The flask was heated to 100° C. in an oil bath with stirring and nitrogen flow. After the contents reached 100° C., the AIBN solution was added to the reaction. Upon complete addition, the reaction was kept at 100° C. for 24 hours. After cooling, the polymer was precipitated in approximately 4 liters of hexane, rinsed twice with 200 ml of hexane, and dried in vacuum oven at 50° C. overnight.
2. Anti-Reflective Coating Formulation

To make this formulation, 0.3498 grams of the polymer prepared in Part 1 of this Example 5, 31.77 grams of PGME, 7.93 grams of PGMEA, 0.0986 grams of tris[4-(vinyloxy)butyl] trimellitate (obtained from Aldrich, Milwaukee, Wis.), 0.0221 grams of triethanolamine quencher (obtained from Aldrich, Milwaukee, Wis.) in 10% PGME solution, 0.0755 grams of 9-anthracenecarboxylic acid (obtained from Aldrich, Milwaukee, Wis.), and 0.0103 grams of triphenyl sulfonium perfluoro butanesulfonate (obtained from Aldrich, Milwaulkee, Wis.) were combined and filtered through 0.1-micron endpoint filter. The formulation was spin-coated at 1,500 rpm onto a silicon substrate and then baked at 165° C. The optical constants at 193 nm were measured using a VASE and were determined to be n=1.64 and k=0.40. The film was rinsed with ethyl lactate to test the film's resistance to the resist solvent, exposed to light from a mercury-xenon lamp, post-exposure baked at 130° C. for 90 seconds, and immersed in developer (ME-319, obtained from Shipley) for 60 seconds. Table 4 below shows that the anti-reflective coating had good solvent resistance, and that it could only be removed by an alkaline developer after exposure.

TABLE 4

| | | | | | Thickness | |
|---|---|---|---|---|---|---|
| | | | Thickness | | After | |
| | Thickness | | After | | Exposure, | |
| | After | | Development | | PEB^{a}, | |
| Initial | 20 sec. | | (No | | and | |
| Thickness | EL Rinse | % | Exposure) | % | Development | % |
| (Å) | (Å) | Loss | (Å) | Loss | (Å) | Loss |
| 399 | 393 | 1.48 | 415 | 5.6 | 0 | 100 |

^{a}Post-exposure bake

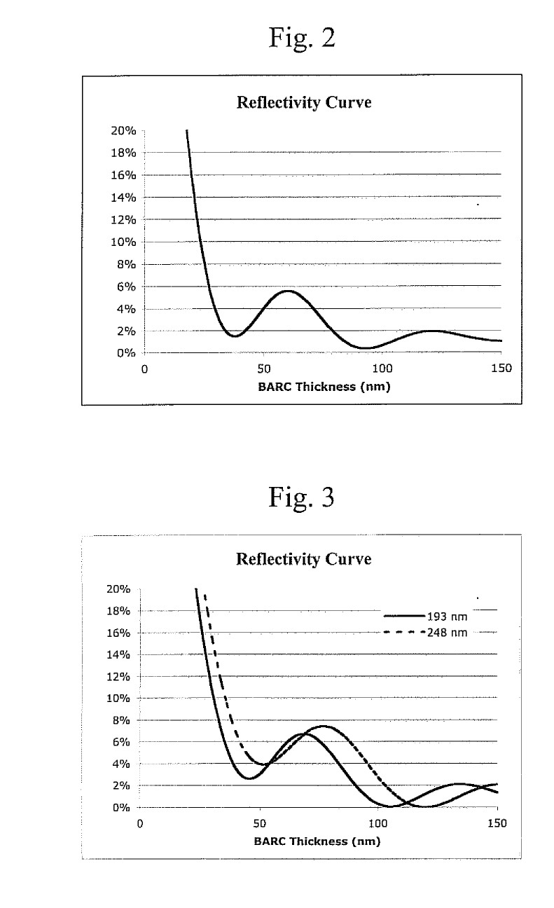

The reflectivity curve for this formulation at 193 nm was determined using PROLITH, and this curve is shown in FIG. 2. It can be seen that the first minimum thickness occurred at about 35 nm, the first maximum thickness occurred at about 60 nm, and the second minimum thickness occurred at about 95 nm.

### Example 6

To make this formulation, 0.1328 grams of the polymer prepared in Part 1 of Example 5, 11.79 grams of PGME, 2.94 grams of PGMEA, 0.154 grams of vinyl ether crosslinker prepared in Part 3 of the Material and Methods Section above, 0.0102 grams of triethanolamine quencher in 10% PGME solution, 0.1324 grams of 3,7-dihydroxy-2-naphthoic acid (obtained from Aldrich, Milwaukee, Wis.), and 0.0162 grams of triphenyl sulfonium perfluoro butane sulfonate were combined and filtered through 0.1-micron endpoint filter. The formulation was spin-coated at 1,500 rpm onto a silicon substrate and then baked at 180° C. The optical constants at 193 nm were measured using a VASE and were determined to be n=1.53 and k=0.311, and at 248 nm were determined to be n=1.71 an k=0.315. The film was exposed to light from a mercury-xenon lamp, post-exposure baked at 130° C. for 90 seconds, and immersed in developer (MF-319) for 60 seconds. Table 5 below shows that the anti-reflective layer could be removed by an alkaline developer after exposure.

TABLE 5

| | Thickness After | | Thickness After | |
|---|---|---|---|---|
| Initial | Development | | Exposure, PEB^{a}, | |
| Thickness | (No Exposure) | | and Development | |
| (Å) | (Å) | % Loss | (Å) | % Loss |
| 710 | 655 | 8.3 | 0 | 100 |

^{a}Post-exposure bake

The reflectivity curves for this formulation were determined at 193 and 248 nm using PROLITH, and those curves are shown in FIG. 3. It can be seen that the first minimum thickness at 193 nm occurred at about 45 nm, the first maximum thickness occurred at about 70 nm, and the second minimum thickness occurred at about 105 nm. The first minimum thickness at 248 nm occurred at about 52 nm, the first maximum thickness occurred at about 80 nm, and the second minimum thickness occurred at about 120 nm.

### Example 7

1. Chromophore Synthesis

To synthesize a chromophore, 6.86 grams of tris(2,3-epoxy)propyl isocyanurate (TEPIC), 13.11 grams of α-cyano-4-hydroxycinnamic acid, 0.94 grams tetrabutylphosphonium bromide, and 79.89 grams of PGME were added to a 250-mL, two-necked, round bottom flask equipped with a stir bar, nitrogen inlet, and condenser with nitrogen outlet. The mixture was stirred, and a flow of nitrogen was started. The flask was immersed in an oil bath and heated to 110° C. for 24 hours. A clear, yellow liquid was obtained. The solution was allowed to cool to room temperature and transferred to a Nalgene bottle for storage.
2. Polymer Synthesis

In this procedure, 9.00 g of cyclohexyl acrylate and 5.02 g of methacrylic acid were added to a 250-ml, 2-necked flask equipped with a stir bar, addition funnel with nitrogen inlet, and a condenser with a nitrogen outlet. These monomers were dissolved by the addition of 50.02 g of PGME and stirring under a nitrogen atmosphere.

Next, 2.99 g of dicumyl peroxide were dissolved in 36.08 g of PGME. The solution was transferred to the addition funnel. The flask was immersed in an oil bath and heated to reflux. The dicumyl peroxide solution was added to the refluxing monomer solution and kept at reflux for 24 hours. A very light yellow solution was obtained. A molecular weight (wt. ave.) of 18,000 Daltons was obtained by gel-permeation chromatography.
3. Anti-Reflective Coating Formulation

To make this anti-reflective coating formulation, 0.3219 grams of the polymer prepared in Part 2 of this Example 7, 10.37 grams of PGME, 2.99 grams of PGMEA, 0.1051 grams of vinyl ether crosslinker prepared in Part 1 of Example 6, 1.1781 grams of the chromophore prepared in Part 1 of this Example 7, and 0.0435 grams of an ionic PAG (DTS-102, a sulfonium salt, obtained from Midori Kagaku, Japan) were combined and filtered through 0.1-micron endpoint filter. The formulation was spin-coated at 1,500 rpm onto a silicon substrate and then baked at 150° C. The optical constants at 365 nm were measured using a VASE and were determined to be n=1.71 and k=0.29. The film was exposed to light from a mercury-xenon lamp, post-exposure baked at 130° C. for 90 seconds, and immersed in developer (MF-319) for 60 seconds. Table 6 below shows that the anti-reflective coating could be removed by an alkaline developer after exposure.

TABLE 6

| | Thickness After | |
|---|---|---|
| Initial | Exposure, PEB^{a}, | |
| Thickness | and Development | |
| (Å) | (Å) | % Loss |
| 933 | 0 | 100 |

^{a}Post-exposure bake

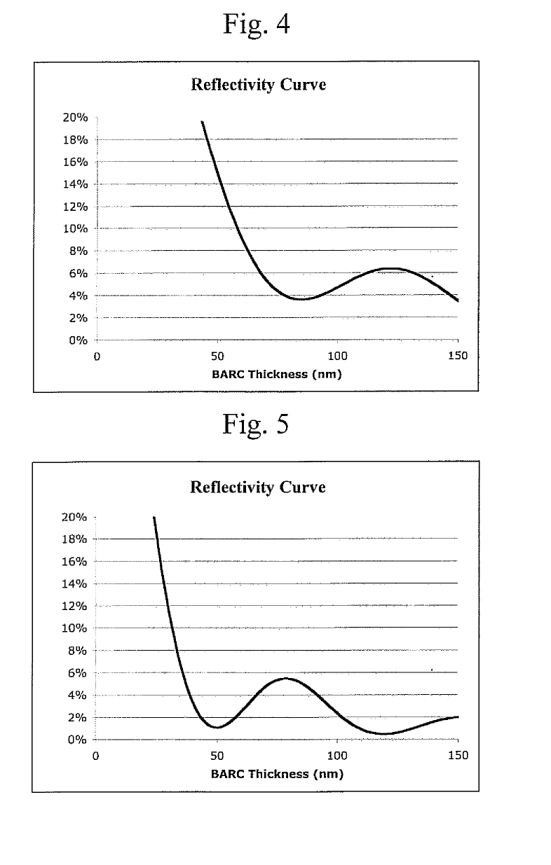

The reflectivity curve for this formulation was determined at 365 nm using PROLITH, and that curve is shown in FIG. 4. It can be seen that the first minimum thickness occurred at about 85 nm, and the first maximum thickness occurred at about 120 nm.

### Example 8

1. Chromophore Synthesis

In this procedure, 10.77 g tris(2,3-epoxypropyl) isocyanurate, 19.23 g 3,7-dihydroxy-2-naphthoic acid, 0.32 g tetrabutylphosphonium bromide, and 70.0 g PGME were added to a 250-ml, 2-necked flask equipped with stir bar, nitrogen inlet, and condenser. The flask was heated to 100° C. in an oil bath for 24 hours with stirring and nitrogen flow. After cooling, the chromophore was precipitated in approximately 500 ml of water, rinsed one time with 100 ml of water, and dried in a vacuum oven at 50° C. overnight.
2. Anti-Reflective Coating Formulation

To make this Formulation, 0.3233 grams of the polymer prepared in Part 2 of Example 7, 11.33 grams of PGME, 2.97 grams of PGMEA, 0.1103 grams of vinyl ether crosslinker prepared in Part 1 of Example 6, 0.2369 grams of the chromophore prepared in Part 1 of this Example 8, and 0.0158 grams of triphenyl sulfonium perfluoro butanesulfonate were combined and filtered through 0.1-micron endpoint filter, The formulation was spin-coated at 1,500 rpm onto a silicon substrate and then baked at 160° C. The optical constants at 248 nm were measured using a VASE and were determined to be n=1.69 and k=0.41. The film was exposed to light from a mercury-xenon lamp, post-exposure baked at 130° C. for 90 seconds, and immersed in developer (MF-319) for 60 seconds. Table 7 below shows that the anti-reflective coating could be removed by an alkaline developer after exposure.

TABLE 7

| | Thickness After | | Thickness After | |
|---|---|---|---|---|
| Initial | Development | | Exposure, PEB^{a}, | |
| Thickness | (No Exposure) | | and Development | |
| (Å) | (Å) | % Loss | (Å) | % Loss |
| 760 | 709 | 6.7 | 0 | 100 |

^{a}Post-exposure bake

The reflectivity curve for this formulation was determined at 248 nm using PROLITH, and that curve is shown in FIG. 5. It can be seen that the first minimum thickness occurred at about 49 nm, the first maximum thickness occurred at about 80 nm, and the second minimum thickness occurred at about 120 nm.

We claim:

1. A method of forming an ion implant area, said method comprising:
providing a structure comprising a substrate, an anti-reflective layer adjacent the substrate, and a photoresist adjacent the anti-reflective layer, the anti-reflective layer having at least one opening formed therein and in communication with at least one opening formed in the photoresist, the anti-reflective layer comprising a crosslinked compound comprising linkages having the formula 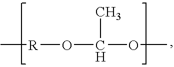
where R is selected from the group consisting of aryls, —CO—, —SO—, —S—, and —CONH—; and
directing ions at the structure so as to cause at least some of the ions to become implanted within the substrate so as to form the ion implant area in the substrate.

2. The method of claim 1, wherein said providing comprises:
applying a composition to said substrate to form said anti-reflective layer, said composition comprising:
a compound selected from the group consisting of polymers, oligomers, and mixtures thereof, said compound comprising an acid group;
a vinyl ether crosslinker; and
a solvent system, said compound and crosslinker being dissolved or dispersed in said solvent system,
crosslinking the compound in said anti-reflective layer;
applying a photoresist to said anti-reflective layer;
exposing said photoresist and anti-reflective layer to light to yield respective exposed portions of said photoresist and said anti-reflective layer; and
contacting said layer with a developer so as to remove said exposed portions from said substrate to form the at least one opening in the anti-reflective layer and the at least one opening in the photoresist.

3. The method of claim 2, wherein said crosslinking step comprises thermally crosslinking said compound.

4. The method of claim 2, wherein said crosslinking step yields a layer of composition that is substantially insoluble in photoresist solvents.

5. The method of claim 2, where said exposing step yields a layer of composition that is substantially soluble in photoresist developers.

6. The method of claim 2, wherein said exposing step results in the breaking of the bond (*) of the linkage having the formula

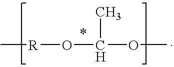

7. The method of claim 2, said composition further comprising an acid generator.

8. The method of claim 7, wherein said acid generator is a photoacid generator.

9. The method of claim 2, wherein said compound is not acid-sensitive.

10. The method of claim 2, wherein said acid group is free of protective groups.

11. The method of claim 2, wherein said compound comprises protected acid groups and unprotected acid groups, and the molar ratio of protected acid groups to unprotected acid groups is from about 1:3 to about 3:1.

12. The method of claim 2, wherein said composition further comprises a chromophore.

13. The method of claim 2, wherein said vinyl ether crosslinker has the formula R—(X—O—CH═CH₂)ₙ, where:
R is selected from the group consisting of aryls and alkyls;
each X is individually selected from the group consisting of alkyls, alkoxys, carboxys, and combinations of two or more thereof and
n is 2-6.

14. The method of claim 13, wherein said vinyl ether crosslinker is selected from the group consisting of ethylene glycol vinyl ether, trimethylolpropane trivinyl ether, 1,4-cyclohexane dimethanol divinyl ether, 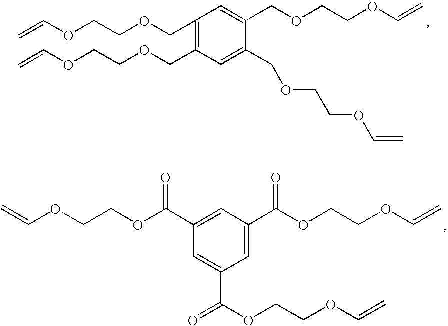
and mixtures thereof.

15. The method of claim 2, wherein said acid group is a carboxylic acid.

16. The method of claim 1, wherein said substrate is selected from the group consisting of silicon, aluminum, tungsten, tungsten silicide, gallium arsenide, germanium, tantalum, tantalum nitrite, and SiGe.

17. The method of claim 1, wherein said ion implant area is formed below said at least one anti-reflective layer opening.

18. The method of claim 1, wherein said ions are selected from the group consisting of ions of the Groups III-V elements of the Periodic Table.

19. The method of claim 1, wherein said ions are selected from the group consisting of boron, nitrogen, phosphorus, arsenic, boron difluoride, indium, antimony, germanium, silicon, hydrogen, argon, beryllium, carbon, fluorine, gallium, oxygen, and helium ions.

20. The method of claim 2, further comprising baking said anti-reflective layer after said exposing.

21. A structure comprising:
a substrate comprising at least one ion implanted area;
an anti-reflective layer adjacent the substrate, the anti-reflective layer having at least one opening formed therein and comprising a crosslinked compound comprising linkages having the formula 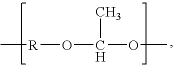
where R is selected from the group consisting of aryls, —CO—, —SO—, —S—, and —CONH—; and
a photoresist adjacent the anti-reflective layer, the photoresist having at least one opening formed therein and in communication with the at least one opening formed in the anti-reflective layer.

22. The structure of claim 21, wherein said ion implanted area is below said anti-reflective layer opening.

23. The structure of claim 21, wherein said anti-reflective layer is substantially insoluble in photoresist solvents.

24. The structure of claim 21, wherein said substrate is selected from the group consisting of silicon, aluminum, tungsten, tungsten silicide, gallium arsenide, germanium, tantalum, tantalum nitrite, and SiGe.

25. The structure of claim 21, wherein said ion implanted area comprises ions selected from the group consisting of ions of the Groups III-V elements of the Periodic Table.

26. The structure of claim 21, wherein said ions are selected from the group consisting of boron, nitrogen, phosphorus, arsenic, boron difluoride, indium, antimony, germanium, silicon, hydrogen, argon, beryllium, carbon, fluorine, gallium, oxygen, and helium ions.

27. The structure of claim 21, said anti-reflective layer further comprising a chromophore.

28. A method of forming an ion implant area, said method comprising:
applying a photosensitive, developer soluble, anti-reflective layer to a substrate to form an intermediate structure; and
directing ions at the intermediate structure so as to cause at least some of the ions to become implanted within the substrate so as to form the ion implant area in the substrate.

29. The method of claim 28, wherein said layer comprises:
a compound selected from the group consisting of polymers, oligomers, and mixtures thereof, said compound comprising an acid group;
a vinyl ether crosslinker; and
a solvent system, said compound and crosslinker being dissolved or dispersed in said solvent system.

30. The method of claim 29, said layer further comprising a chromophore.

31. The method of claim 28, further comprising:
crosslinking said anti-reflective layer; and
applying a photoresist to said crosslinked anti-reflective layer prior to said directing ions.

32. The method of claim 31, further comprising:
exposing said photoresist and anti-reflective layer to light to yield respective exposed portions of said photoresist and said anti-reflective layer; and
contacting said layer with a developer so as to remove said exposed portions from said substrate to form at least one opening in the anti-reflective layer and at least one opening in the photoresist.

33. The method of claim 32, further comprising baking said anti-reflective layer after said exposing.

34. The method of claim 31, wherein said crosslinking yields an anti-reflective layer that is substantially insoluble in photoresist solvents.

35. The method of claim 32, where said exposing yields an anti-reflective layer that is substantially soluble in photoresist developers.

36. The method of claim 28, wherein said substrate is selected from the group consisting of silicon, aluminum, tungsten, tungsten silicide, gallium arsenide, germanium, tantalum, tantalum nitrite, SiGe.

37. The method of claim 32, wherein said ion implant area is formed below said at least one anti-reflective layer opening.

38. The method of claim 28, wherein said ions are selected from the group consisting of ions of the Groups III-V elements of the Periodic Table.

39. The method of claim 28, wherein said ions are selected from the group consisting of boron, nitrogen, phosphorus, arsenic, boron difluoride, indium, antimony, germanium, silicon, hydrogen, argon, beryllium, carbon, fluorine, gallium, oxygen, and helium ions.

40. A structure comprising:
a substrate comprising ions implanted therein; and
a developer soluble anti-reflective layer adjacent said substrate.

41. The structure of claim 40, wherein said layer comprises:
a compound selected from the group consisting of polymers, oligomers, and mixtures thereof said compound comprising an acid group;
a vinyl ether crosslinker; and
a solvent system, said compound and crosslinker being dissolved or dispersed in said solvent system.

42. The structure of claim 41, said layer further comprising a chromophore.

43. The structure of claim 40, further comprising a photoresist layer adjacent said anti-reflective layer.

44. The structure of claim 40, wherein said substrate is selected from the group consisting of silicon, aluminum, tungsten, tungsten silicide, gallium arsenide, germanium, tantalum, tantalum nitrite, and SiGe.

45. The structure of claim 40, wherein said ions are selected from the group consisting of ions of the Groups III-V elements of the Periodic Table.

46. The structure of claim 40, wherein said ions are selected from the group consisting of boron, nitrogen, phosphorus, arsenic, boron difluoride, indium, antimony, germanium, silicon, hydrogen, argon, beryllium, carbon, fluorine, gallium, oxygen, and helium ions.

47. A method of forming microelectronic devices, said method comprising:
providing a substrate;
forming a layer of a photosensitive, anti-reflective composition on the substrate;
crosslinking said layer, said crosslinked layer having a thickness that is within about 20% of the anti-reflective composition's first maximum thickness; and
applying a photoresist to said layer.

48. The method of claim 47, said composition comprising:
a compound selected from the group consisting of polymers, oligomers, and mixtures thereof, said compound comprising an acid group;
a vinyl ether crosslinker; and
a solvent system, said compound and crosslinker being dissolved or dispersed in said solvent system.

49. The method of claim 47, further comprising:
exposing said photoresist and anti-reflective layer to light to yield respective exposed portions of said photoresist and said anti-reflective layer; and
contacting said photoresist and anti-reflective layer with a developer so as to remove said exposed portions from said substrate.

50. The method of claim 49, further comprising baking said anti-reflective layer after said exposing.

51. The method of claim 47, wherein said substrate is selected from the group consisting of silicon, aluminum, tungsten, tungsten silicide, gallium arsenide, germanium, tantalum, tantalum nitrite, and SiGe.

52. A structure comprising:
a substrate;
a crosslinked layer of a developer soluble anti-reflective composition on the substrate, said crosslinked layer having a thickness that is within about 20% of the anti-reflective composition's first maximum thickness; and
a photoresist adjacent the crosslinked layer.
